(19) United States
(12) Patent Application Publication
(10) Pub. No.: US 2009/0087629 A1
(43) Pub. Date: Apr. 2, 2009

(54) INDIUM-TIN-OXIDE COMPATIBLE OPTICALLY CLEAR ADHESIVE

(76) Inventors: Albert I. Everaerts, Oakdale, MN (US); Jianhui Xia, Woodbury, MN (US)

Correspondence Address: 3M INNOVATIVE PROPERTIES COMPANY, PO BOX 33427, ST. PAUL, MN, 55133-3427, US

(21) Appl. No.: 12/236,821

(22) Filed: Sep. 24, 2008

Related U.S. Application Data
(60) Provisional application No. 60/975,913, filed on Sep. 28, 2007.

(51) Int. Cl. B32B 7/10; B05D 3/06

(52) U.S. Cl. 428/203; 427/108; 427/516

(57) ABSTRACT

An optically clear pressure sensitive adhesive composition that is compatible with an electro-conductive trace containing indium-tin oxide is provided. The composition at least two components selected from the group: (a) from about 50 to 95 parts component A, an alkyl (meth)acrylate monomer having a T_{g} of about 25° C. or less, wherein the alkyl has 4 to 18 carbon atoms; (b) from about 30 to 50 parts component B, an ester of (meth)acrylate monomer having a T_{g} greater than about 25° C., wherein the alkyl has 4 to 18 carbon atoms; and (c) from about 1 to 40 parts component C, a monomer selected from the group consisting of hydroxy alkyl (meth)acrylate; unsubstituted (meth)acrylamide; N-alkyl susbstituted (meth)acrylamide; N,N-dialkyl substituted (meth)acrylamide; monomer containing urea functionality, a monomer containing lacatam functionality; tertiary amine, alicyclic amine, aromatic amine, and combinations thereof. All parts are based on 100 parts of the adhesive composition.

### CROSS REFERENCE TO RELATED APPLICATION

This application claims the benefit of U.S. Provisional Patent Application No. 60/975,913, filed Sep. 28, 2007, the disclosure of which is incorporated by reference herein in its entirety.

### BACKGROUND

Optically clear pressure sensitive adhesives (OCAs) find wide applications in optical displays. Such applications include, but are not limited to, bonding polarizers to modules of a liquid crystal display (LCD) and attaching various optical films to a glass lens in mobile hand held devices (MHH). The polarizers may be in direct or indirect contact with the OCA.

Recently, there has been an upward trend to introduce and/or combine touch panel functions in various display applications. Touch panels typically include indium-tin oxide (ITO) coated polyethylene terephthale film or ITO coated glass. The ITO is typically in a trace form and is electro-conductive. These ITO coated substrates are often attached to the display modules using OCAs. In some touch panel designs, the OCA can come in direct contact with the electro-conductive ITO traces. In such a case, the OCAs need to be compatible with the ITO trace, i.e., the OCA should cause only minimal change in the resistance of the ITO trace while the OCA remains in contact with the ITO trace.

U.S. Pat. No. 6,599,602 (Bennett et al.) discloses an adhesive polymer that includes the reaction product of an N-vinyl containing monomer selected from the group consisting of (1) N-vinyl caprolactam, N-vinyl pyrrolidone, and N-vinyl imidazole, and combinations thereof and (2) an acrylic acid ester monomer of a non-tertiary alcohol having an alkyl group comprising 4 to 20 carbon atoms. The adhesive polymer is used in an article whereby the adhesive is sandwiched between a first and a second polycarbonate substrate bonding the two. Such an article can be used for digital versatile discs (DVDs). In one embodiment, the article further includes an inorganic layer disposed on a surface of the first polycarbonate substrate and the adhesive polymer is in contact with the inorganic layer. In some embodiments, the inorganic layer is metal, such as aluminum, silver, brass, gold, gold alloy, copper, copper-zinc alloy, copper-aluminum alloy, aluminum-molybdenum alloy, aluminum-tantalum alloy, aluminum-cobalt alloy, aluminum-chromium alloy, aluminum-titanium alloy, and aluminum-platinum alloy and combinations thereof.

### SUMMARY

The present disclosure addresses the need for an OCA that is compatible with an electro-conductive trace containing ITO. The OCA is in direct contact with the ITO trace in, e.g., a touch panel. The ITO-compatible OCA is composed of a pressure sensitive adhesive (PSA) that is neutral or basic in nature, as further explained below in detail.

In one aspect, the present disclosure pertains to an article comprising (a) an optically clear first substrate having an electro-conductive trace comprising indium-tin oxide; (b) an optically clear pressure sensitive adhesive disposed on the first substrate and in contact with the trace, the adhesive comprising at least two components selected from the group consisting of (i) from about 50 to 95 parts component A, an alkyl (meth)acrylate monomer having a T_{g} of about 25° C. or less, wherein the alkyl has 4 to 18 carbon atoms; (ii) from about 30 to 50 parts component B, an ester of (meth)acrylate monomer having a T_{g} greater than about 25° C.; and (iii) from about 1 to 40 parts component C, a monomer selected from the group consisting of hydroxy alkyl (meth)acrylate, unsubstituted (meth)acrylamide, N-alkyl substituted (meth)acrylamide, N,N-dialkyl substituted (meth)acrylamide, monomer containing urea functionality, a monomer containing lactam functionality, tertiary amine, alicyclic amine, aromatic amine, and combinations thereof. All parts are based on 100 parts of adhesive.

In another aspect, the present disclosure pertains to a method of making an article comprising the steps of (a) providing an optically clear first substrate having an electro-conductive trace comprising indium-tin oxide; (b) providing a pressure sensitive adhesive comprising an optically clear second substrate having a major surface; and an optically clear adhesive disposed on the major surface of the second substrate, the adhesive comprising at least two components selected from the group consisting of (i) from about 50 to 95 parts component A, an alkyl (meth)acrylate monomer having a T_{g} of about 25° C. or less, wherein the alkyl has 4 to 18 carbon atoms; (ii) from about 30 to 50 parts component B, an ester of (meth)acrylate monomer having a T_{g} greater than about 25° C.; and (iii) from about 1 to 15 parts component C, a monomer selected from the group consisting of hydroxy alkyl(meth)acrylate, unsubstituted (meth)acrylamide, N-alkyl substituted (meth)acrylamide, N,N-dialkyl substituted (meth)acrylamide, monomer containing urea functionality, monomer containing lactam functionality, tertiary amine, alicyclic amine, aromatic amine, and combinations thereof, and (c) laminating the pressure sensitive adhesive to the first substrate such that the optically clear adhesive is in contact with the electro-conductive trace. All parts are based on 100 parts of adhesive.

In yet another aspect, the present disclosure pertains to a method of making an article comprising the steps of (a) providing a cavity having optically clear substantially coplanar first and second substrates separated by an air gap; (b) providing an adhesive composition comprising (i) from about 50 to 95 parts component A, an alkyl (meth)acrylate monomer having a T_{g} of about 25° C. or less, wherein the alkyl has 4 to 18 carbon atoms; and at least one component selected from the group consisting of (ii) from about 30 to 50 parts component B, an ester of (meth)acrylate monomer having a T_{g} greater than about 25° C.; and (iii) from about 1 to 40 parts component C, a monomer selected from the group consisting of hydroxy alkyl(meth)acrylate, unsubstituted (meth)acrylamide, N-alkyl substituted (meth)acrylamide, N,N-dialkyl substituted (meth)acrylamide, monomer containing urea functionality, monomer containing lactam functionality, tertiary amine, alicyclic amine, aromatic amine, and combinations thereof, and (iv) less than about 5 parts of an initiator; (c) delivering the adhesive composition to the cavity; and (d) curing the adhesive composition. The parts for components A, B, and C are based on 100 parts total of the 3 components. The parts for the initiator are based on 100 parts of components A, B, and C.

In one exemplary application, the articles and the method of making the articles described in the present disclosure can be integrated into electronic devices such as, but not limited to, LCD panel, cell phone, hand held device, and a laptop computer.

In this disclosure, a material, such as an adhesive, a substrate, or a layer, may be considered to be optically clear if it exhibits an optical transmission of at least about 90%, or even higher, and a haze value of below about 5% or even lower, as measured on a 25 micron thick sample in the matter described below in the Example section.

Other features and advantages will be apparent from the following detailed description and the claims. The above summary is not intended to describe each illustrated embodiment or every implementation of the present disclosure. The detailed description that follows more particularly exemplifies certain presently preferred embodiments using the principles disclosed herein.

### BRIEF DESCRIPTION OF THE DRAWINGS

The invention can be better described with reference to the drawings, wherein:

FIG. 1 is a cross-sectional view of an exemplary article according to the present disclosure;

FIG. 2 is a schematic view of an exemplary method of making an article according to the present disclosure;

FIGS. 3a and 3b are schematic views of another exemplary method of making an article according to the present disclosure;

FIG. 4 shows the relationship of the percent resistance increase as a function of time for Examples 1 to 3 and Comparative Example 1; and

FIG. 5 shows the relationship of the percent resistance increase as a function of time for Examples 4 to 6 and Comparative Example 2.

The figures are idealized, are not drawn to scale, and are intended only for illustrative purposes.

### DETAILED DESCRIPTION

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5). All parts recited herein are by weight unless otherwise indicated.

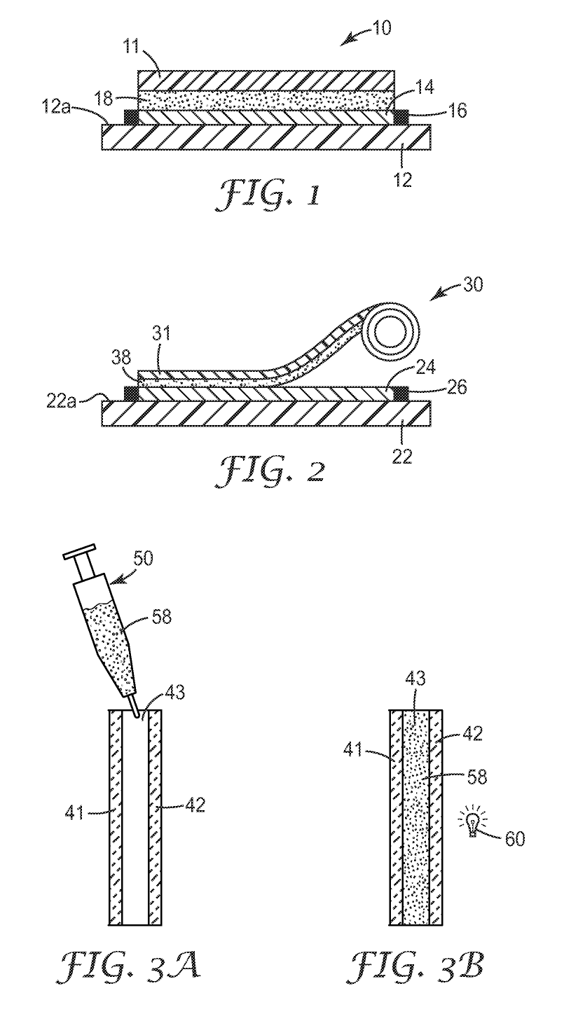

Turning now to the figures, FIG. 1 depicts a cross-sectional view of an exemplary article 10 having a first substrate 12. Disposed on a first surface 12a of the substrate is an electro-conductive trace 14 containing indium-tin oxide. The trace forms a grid on the first surface 12a. The edges of the trace end at electrical connector pads 16. An optically clear adhesive 18 is disposed on the trace. Because the trace is in a grid format, a portion of the adhesive 18 may be in direct contact with the first surface 12a of the first substrate 12. Optionally, the embodiment includes a second substrate 11 disposed on the adhesive 18. The first substrate and second substrate, if used, are optically clear. In some exemplary embodiments, they can be plastic, such as a plastic slabs, polymeric films, or glass.

FIG. 2 depicts a schematic view of an exemplary process of making an article of FIG. 1. The process includes a step of providing a first substrate 22 having a first surface 22a. An electro-conductive trace 24 with electrical connector pads 26 is disposed on the first surface 22a. A roll of transfer tape 30 is provided. The roll of tape includes an optically clear pressure sensitive adhesive 38 coated on a liner 31. Optionally, the liner includes release coatings allowing for the roll of tape to unwind. The transfer tape is laminated to the first surface 22a of the first substrate 22 such that the adhesive 38 is in contact with the trace 24. In one method, the liner 31 functions as a second substrate and becomes a part of the article. In another method, the liner can be removed and discarded and a second substrate can be laminated on to the adhesive 38. While FIG. 2 depicts the use of a transfer tape, the method can also be practiced using cut sheets of transfer tapes.

FIGS. 3a and 3b depict schematic views of another exemplary process of making an article according to the present disclosure. The process includes a step of providing a cavity 43 formed by first and second substrates 41 and 42, which may be substantially coplanar with one another. A delivery mechanism, such as a syringe 50 contains an optically clear adhesive composition 58. In FIG. 3b, the adhesive composition 58 has been dispensed from the syringe and fills the cavity. A light source 60, such as an ultraviolet light source or an infrared light source, can be used to cure the adhesive composition. This particular method has the advantage in that the adhesive composition, while in liquid form, can better accommodate non-uniform thickness between the first and second substrate or where the substrates are rough. This method is particularly suited for the situation where the first and second substrates are glass.

### Optically Clear Adhesive

The OCA includes the component A and at least one of the B or C components. While each component is discussed below in detail, in preferred embodiments, none of the components contain acid functionality. The adhesive composition, however, can include minor amounts, e.g., less than 1 part per 100 parts of components A, B, and C of an acid containing compound, so long as the acid content does not appreciably interfere with the electrical performance of the ITO containing trace over the life span of the article.

Component A is an alkyl (meth)acrylate monomer having a glass transition temperature (T_{g}) of about 25° C. or less, wherein the alkyl has 4 to 18 carbon atoms. Suitable examples include n-butyl acrylate, 2-ethyl hexyl(meth)acrylate, isooctyl acrylate, 2-methyl hexyl acrylate, and combinations thereof. When used, the OCA has from 50 to 95 parts component A.

Component B is an ester of (meth)acrylate monomer having a T_{g} greater than about 25° C. Suitable examples include methyl(meth)acrylate, ethyl(meth)acrylate, isobornyl(meth)acrylate, and combinations thereof. When used, the OCA has from 30 to 50 parts component B.

Component C a monomer selected from the group consisting of hydroxy alkyl(meth)acrylate, unsubstituted (meth)acrylamide, N-alkyl substituted (meth)acrylamide, N,N-dialkyl substituted (meth)acrylamide, monomer containing urea functionality, monomer containing lactam functionality, tertiary amine, alicyclic amine, aromatic amine, and combinations thereof. When used, the OCA has from 1 to 40 parts component C. Suitable examples of hydroxy alkyl(meth)acrylate include 2-hydroxyethyl(meth)acrylate, 3-hydroxypropyl(meth)acrylate, and combinations thereof. A suitable example of N-alkyl substituted (meth)acrylamide is N-octyl acrylamide. Suitable examples of N,N-dialkyl substituted (meth)acrylamide include N,N-dimethyl acrylamide, N-N diethylacrylamide, and a combination thereof. Suitable examples of tertiary amine, alicyclic amine, and aromatic amine is selected from the group consisting of vinyl pyridine, vinyl imidazole, and N,N-dialkyl amino alkyl (meth)acrylate, wherein the alkyl has 1 to 4 carbon atoms.

In some embodiments, the pressure-sensitive adhesive components (A, B, and C recited above) may be blended to form an optically clear mixture. One or more of the polymeric components may be independently crosslinked or crosslinked with a common cross-linker. Such crosslinkers include thermal crosslinkers which are activated during the drying step of preparing solvent coated adhesives. Such thermal crosslinkers may include multifunctional isocyanates, aziridines and epoxy compounds. In addition, photo initiators may be used to crosslink the pressure sensitive adhesive. Suitable photo initiators may include benzophenones and 4-acryloxybenzophenones.

The OCA can be produced using a solvent-based solution polymerization or using bulk polymerization.

In a solution polymerization, solvent-based OCA, the components and additives are mixed in an organic solvent, coated from solution, and then dried. The solvent-based OCA is cross-linked during the drying process, or in some cases it may be crosslinked after the drying step. Such cross-linkers include thermal crosslinkers, which are activated during or after the drying step of preparing solvent coated adhesives. The solvent-based OCA may be coated upon suitable flexible backing materials by any known coating technique to produce adhesive coated sheet materials.

The flexible backing materials may be any materials conventionally used as a tape backing, optical film, release liner or any other flexible material, so long as it is optically clear or removed, if not optically clear, prior to assembly into the articles of the present disclosure. Typical examples of flexible backing materials used as tape backing that may be useful for the adhesive compositions include those made of plastic films such as polypropylene, polyethylene, polyurethane, polyvinyl chloride, polyester (e.g., polyethylene terephthalate), cellulose acetate, and ethyl cellulose. Some flexible backing may have coatings. For example a release liner may be coated with a low adhesion component, such as silicone. Illustrative coating techniques include roll coating, spray coating, knife coating, die coating and the like. Solution processing as described herein lends itself well for producing thin e.g. 25 to 75 micron (0.001 to 0.003 inch) OCA films for use as transfer tapes. The resulting tape has low volatile residuals after oven drying.

In a bulk polymerization, a monomer premix comprising the component A and at least one of components B, and C are mixed with an initiator (either a photo or a thermal initiator), which is then partially polymerized using radiation, such as ultraviolet radiation, forming a coatable syrup. Optionally, crosslinkers are added to the syrup before it is coated onto a flexible substrate. Bulk polymerization as described herein lends itself well for producing thick (e.g., 0.005 to 0.040 inch) OCA films for use in rigid-to-rigid lamination applications. For example, such a thick OCA film can be laminated to a piece of glass or be used to laminate two pieces of glasses together.

In yet another method, the components of the OCA (components A, B, and C) are mixed with the additives (e.g., initiator (photo or thermal initiators) and optionally crosslinker). The monomer or monomer mixture can be used in a gap-filling application, as in, e.g., filling a space between two substrates such as between two glass substrates. In one application, a syringe is used to deliver the syrup into the gap, and the syrup is cured using ultraviolet radiation. Such a method and delivery mechanism is well suited for gaps with varying thicknesses or where the substrates have surfaces that are not substantially flat.

### EXAMPLES

Where not otherwise specified, a chemical supply house, such as Aldrich, Milwaukee, Wis., supplied the materials used in the examples.

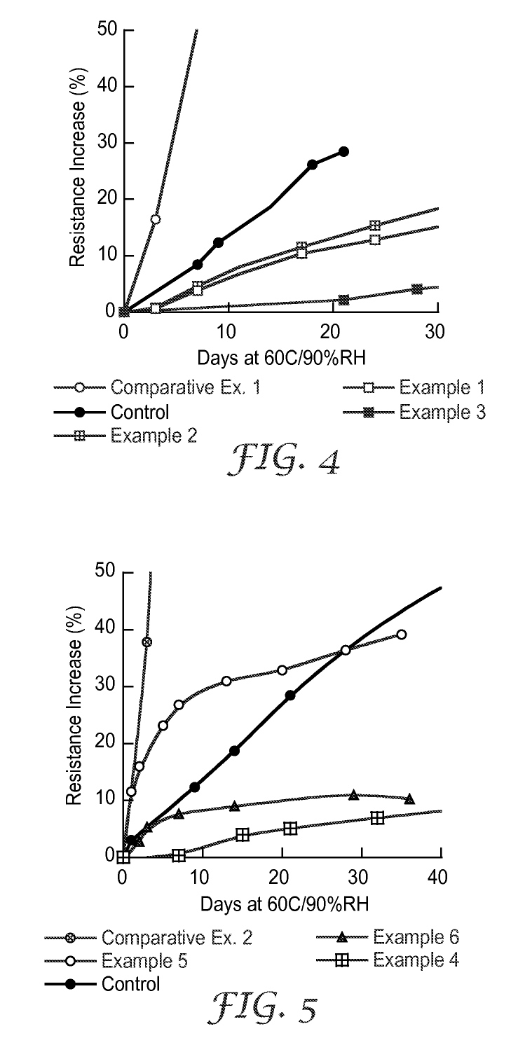

The OCAs of Examples 1 to 3 and the adhesive of Comparative Example 1 were made from a solution polymerization process. FIG. 4 shows the relationship of the surface resistance of the electro-conductive ITO containing trace as a function of time for these samples.

The OCAs of Examples 4 to 6 and the adhesive of Comparative Example 2 were made from a bulk polymerization process. FIG. 5 shows the relationship of the surface resistance of the electro-conductive ITO containing trace as a function of time for these samples.

Each of the OCAs of Examples 1 to 6 had an optical transmission value greater than 90% and a haze value below 5%.

The control sample included an ITO trace exposed to ambient conditions, i.e., no OCA adhesive was laminated onto the PET substrate having the ITO containing trace.

### Example 1

A one liter bottle was charged with VAZO67, which is 2,2′-azobis(2-methyl butyro nitrile) from Du Pont, Wilmington, Del., (0.2 g), n-butyl acrylate (BA) (58 g), methyl acrylate (MA) (40 g), 2-hydroxy ethyl acrylate (HEA) (2 g), and ethyl acetate (EtOAc) (150 g). The solution was de-aerated with nitrogen for 10 minutes and was then heated, with agitation, at 58° C. in a water bath for 24 hour. Additional EtOAc (210 g) and toluene (40 g) were added to yield a viscous solution at 20% solids. The solution OCA was then mixed with a desired amount of a multifunctional isocyanate crosslinker (Desmodur L-75 available from Bayer) and placed on a mechanical roller for 30 minutes. The solution was then coated on a release liner and dried at 70° C. for 30 minute to a final OCA film thickness of 0.001 inch.

### Example 2

The same procedure as in Example 1 was repeated, except that the monomers charged were BA (56 g), MA (35 g), N,N-dimethylacrylamide (NNDMA) (5 g), and 2-hydroxy ethyl acrylate (HEA) (4 g).

### Example 3

A one liter bottle was charged with V-601 (0.2 g) (from Wako Specialty Chemicals), isooctyl acrylate (IOA) (93 g), acrylamide (97 g), EtOAc (110 g), and methanol (12.22 g). The solution was de-aerated with nitrogen for 10 minutes and was then heated at 58° C. in a water bath for 24 hours while agitating. Additional EtOAc (148.8 g), toluene (42.5 g), and methanol (41 g) were added to yield a solution at 22% solids. The solution was then coated on a release liner and dried at 70° C. for 30 minutes to a final OCA thickness of 0.001 inch.

### Comparative Example 1

A one liter bottle was charged with VAZO67 (0.2 g), IOA (93 g), acrylic acid (AA) (7 g), and EtOAc (150 g). The solution was de-aerated with nitrogen for 10 min and was then heated at 58° C. in a water bath for 24 hours while agitating. Additional EtOAc (210 g) and toluene (40 g) were added to yield a viscous solution at 20% solids. The solution adhesive was then mixed with the desired amount (0.10 part crosslinker per 100 pars of adhesive) of a bisamide crosslinker (1,1′-isophthaloyl-bis(2-methylaziridine), CAS No. 7652-64-4) and placed on a mechanical roller for 30 minutes. The solution was then coated on a release liner and dried at 70° C. for 30 minutes to a final OCA thickness of 0.001 inch.

### Example 4

A monomer premix was prepared using 2-ethylhexyl acrylate (2-EHA) (55 parts), isobornyl acrylate (iBOA) (40 parts), N-vinyl caprolactam (NVC) (5 parts), and 2,2-dimethoxy-2-phenylacetophenone photo-initiator (0.04 parts) (Irgacure 651, available from Ciba Specialty Chemicals, Tarrytown, N.Y.). This mixture was partially polymerized under a nitrogen-rich atmosphere by exposure to ultraviolet radiation to provide a coatable syrup having a viscosity of about 3000 cps. Then 1,6-hexanediol diacrylate (HDDA) (0.1 part) and additional Irgacure 651 (0.16 part) were added to the syrup and it was then knife coated in-between two silicone-treated PET release liners at a thickness of 0.007 inch. The resulting composite was then exposed to low intensity ultraviolet radiation (a total energy of 1,000 mJ/cm²) having a spectral output from 300-400 nm with at maximum at 351 nm.

### Example 5

The same procedure as Example 4 was repeated, except that monomers charged were 2-EHA (60 g) and isobornyl acrylate (iBOA) (40 parts).

### Example 6

The same procedure as Example 4 was repeated, except that the monomers charged were 2-EHA (90 g) and NVC (10 parts).

### Comparative Example 2

The same procedure as Example 4 was repeated, except that the monomers charged were IOA (87.5 g) and AA (12.5 g).

In FIG. 4, Comparative Example 1 had the largest increase in surface resistance over time while the sample was conditioned at 70° C. and 90% relative humidity. A large increase in surface resistance is undesirable as it changes the electrical performance of the ITO containing trace. The control sample had the second largest increase in surface resistance, as there is no adhesive to protect the ITO containing trace. The surface resistance data for Examples 1, 2, and 3, however, show that there is a much smaller change in surface resistance as a function of time.

In FIG. 5, Comparative Example 2 had the largest surface resistance increase over time while the sample was conditioned at 70° C. and 90% relative humidity. The data for Examples 4 to 6 show a smaller change in surface resistance as compared to Comparative Example 2.

### Haze and Transmission Testing

A 25 micron thick sample of the OCA was laminated to a 25 micron thick Melinex® polyester film 454 (from DuPont Company, Wilmington, Del.) in a manner so as to assure that no air bubbles are trapped between the film and the adhesive layer. A 75 mm by 50 mm plain micro slide (a glass slide from Dow Corning, Midland, Mich.), that had been wiped three times with isopropanol, was laminated to the adhesive sample using a hand roller to assure no air bubbles were trapped between the adhesive and the glass slide. The percent (%) transmission and haze were measured using a Model 9970 BYK Gardner TCS Plus Spectrophotometer (from BYK Gardner, Columbia, Md.). The background measurement was made with a sandwich of the Melinex® polyester film 454 and the glass slide. The % transmission and the haze of the adhesive sample were then obtained directly on the film/adhesive/glass laminate in the spectrophotometer.

### Compatibility Study of ITO Containing Trace Exposed to OCA

The compatibility of the OCA with the ITO trace was done as follows. A sample of the OCA adhesive was transferred to a 0.0015 inch thick primed polyester (PET) backing to form a tape. The tape was then laminated to a PET film having a major surface coated with ITO trace such that the OCA was in direct contact with the traces to from a laminate. An initial surface resistance was measured on the ITO trace using an ohm meter where electrical leads of the meter are placed across the connector pads. The resulting laminate was conditioned in an oven set at 60° C. and 90% relative humidity. The surface resistance for each sample was measured periodically over a period of 30 to 40 days using an ohm meter. An average of five surface resistance measurements was recorded.

What is claimed is:

1. An article comprising:
an optically clear first substrate having an electro-conductive trace comprising indium-tin oxide;
an optically clear pressure sensitive adhesive disposed on the first substrate and in contact with the trace, the adhesive comprising
from about 50 to 95 parts component A, an alkyl (meth)acrylate monomer having a T_{g} of about 25° C. or less, wherein the alkyl has 4 to 18 carbon atoms; and
at least one component selected from the group consisting of:
from about 30 to 50 parts component B, an ester of (meth)acrylate monomer having a T_{g} greater than about 25° C.; and
from about 1 to 40 parts component C, a monomer selected from the group consisting of hydroxy alkyl(meth)acrylate, unsubstituted (meth)acrylamide, N-alkyl substituted (meth)acrylamide, N,N-dialkyl substituted (meth)acrylamide, monomer containing urea functionality, monomer containing lactam functionality, tertiary amine, alicyclic amine, aromatic amine, and combinations thereof;
wherein all parts are based on 100 parts of adhesive.

2. A method of making an article comprising the steps of:
providing an optically clear first substrate having an electro-conductive trace comprising indium-tin oxide;
providing a pressure sensitive adhesive comprising
an optically clear second substrate having a major surface; and
an optically clear adhesive disposed on the major surface of the second substrate, the adhesive comprising:
from about 50 to 95 parts component A, an alkyl(meth)acrylate monomer having a T_{g} of about 25° C. or less, wherein the alkyl has 4 to 18 carbon atoms; and
at least one component selected from the group consisting of:
from about 30 to 50 parts component B, an ester of (meth)acrylate monomer having a T_{g} greater than about 25° C.; and
from about 1 to 15 parts component C, a monomer selected from the group consisting of hydroxy alkyl(meth)acrylate, unsubstituted (meth)acrylamide, N-alkyl substituted (meth)acrylamide, N,N-dialkyl substituted (meth)acrylamide, monomer containing urea functionality, a monomer containing lactam functionality, tertiary amine, alicyclic amine, aromatic amine, and combinations thereof;
wherein all parts are based on 100 parts of adhesive; and
laminating the pressure sensitive adhesive to the first substrate such that the optically clear adhesive is in contact with the electro-conductive trace.

3. A method of making an article comprising the steps of:
providing a cavity having optically clear substantially coplanar first and second substrates separated by an air gap;
providing an adhesive composition comprising:
from about 50 to 95 parts component A, an alkyl(meth)acrylate monomer having a T_{g} of about 25° C. or less, wherein the alkyl has 4 to 18 carbon atoms; and
at least one component selected from the group consisting of:
from about 30 to 50 parts component B, an ester of (meth)acrylate monomer having a T_{g} greater than about 25° C.; and
from about 1 to 40 parts component C, a monomer selected from the group consisting of hydroxy alkyl(meth)acrylate, unsubstituted (meth)acrylamide, N-alkyl substituted (meth)acrylamide, N,N-dialkyl substituted (meth)acrylamide, monomer containing urea functionality, monomer containing lactam functionality, tertiary amine, alicyclic amine, aromatic amine, and combinations thereof;
wherein the parts for components A, B, and C are based on 100 parts total;
less than about 5 parts of an initiator, based on total parts of components A, B, and C; and
delivering the adhesive composition to the cavity; and
curing the adhesive composition.

4. The article of claim 1, wherein component A is selected from the group consisting of n-butyl acrylate, 2-ethyl hexyl(meth)acrylate, isooctyl acrylate, 2-methyl butyl acrylate, and combinations thereof.

5. The article of claim 1, wherein component B is selected from the group consisting of methyl(meth)acrylate, ethyl(meth)acrylate, isobornyl(meth)acrylate, and combinations thereof.

6. The article of claim 1, wherein the hydroxy alkyl(meth)acrylate is selected from the group consisting of 2-hydroxyethyl(meth)acrylate, 3-hydroxypropyl(meth)acrylate, and combinations thereof.

7. The article of claim 1, wherein the N-alkyl substituted (meth)acrylamide is N-octyl acrylamide.

8. The article of claim 1, wherein the N,N-dialkyl substituted (meth)acrylamide is selected from the group consisting of N,N-dimethyl acrylamide, N-N diethylacrylamide, and a combination thereof.

9. The article of claim 1, wherein the tertiary amine, alicyclic amine, and aromatic amine is selected from the group consisting of vinyl pyridine, vinyl imidazole, and N,N-dialkyl amino alkyl(meth)acrylate, wherein the alkyl has 1 to 4 carbon atoms.

10. The article of claim 1, wherein the electro-conductive trace has an initial resistance value when the adhesive is attached to the first substrate and the trace shows an increase in resistance of less than 50% after the article has been conditioned for forty days at 60° C. and 90% relative humidity.

11. The article of claim 1, wherein the electro-conductive trace has an initial resistance value when the adhesive is attached to the first substrate and the trace shows an increase in resistance of less than 20% after the article has been conditioned for forty days at 60° C. and 90% relative humidity.

12. The article of claim 1, further comprising an optically clear second substrate disposed on the adhesive.

13. The article of claim 12, wherein the first and second substrates are selected from the group consisting of plastic, polymeric film, and glass.

14. The article of claim 1, integrated into an electronic device selected from the group consisting of LCD panel, cell phone, hand held device, and a laptop computer.

15. The method of claim 2, wherein component A is selected from the group consisting of n-butyl acrylate, 2-ethyl hexyl(meth)acrylate, isooctyl acrylate, 2-methyl butyl acrylate, and combinations thereof.

16. The method of claim 2, wherein component B is selected from the group consisting of methyl(meth)acrylate, ethyl(meth)acrylate, isobornyl(meth)acrylate, and combinations thereof.

17. The method of claim 2, wherein the hydroxy alkyl(meth)acrylate is selected from the group consisting of 2-hydroxyethyl(meth)acrylate, 3-hydroxypropyl(meth)acrylate, and combinations thereof.

18. The method of claim 2, wherein the N-alkyl substituted (meth)acrylamide is N-octyl acrylamide.

19. The method of claim 2, wherein the N,N-dialkyl substituted (meth)acrylamide is selected from the group consisting of N,N-dimethyl acrylamide, N-N diethylacrylamide, and a combination thereof.

20. The method of claim 2, wherein the tertiary amine, alicyclic amine, and aromatic amine is selected from the group consisting of vinyl pyridine, vinyl imidazole, and N,N-dialkyl amino alkyl(meth)acrylate, wherein the alkyl has 1 to 4 carbon atoms.

21. The method of claim 2, wherein the electro-conductive trace has an initial resistance value when the adhesive is attached to the first substrate and the trace shows an increase in resistance of less than 50% after the article has been conditioned for forty days at 60° C. and 90% relative humidity.

22. The method of claim 2, wherein the electro-conductive trace has an initial resistance value when the adhesive is attached to the first substrate and the trace shows an increase in resistance of less than 20% after the article has been conditioned for forty days at 60° C. and 90% relative humidity.

23. The method of claim 2, wherein the first and second substrates are selected from the group consisting of plastic and glass.

24. The method of claim 2, wherein the adhesive composition further comprises a crosslinker.

25. The method of claim 3, wherein component A is selected from the group consisting of n-butyl acrylate, 2-ethyl hexyl(meth)acrylate, isooctyl acrylate, 2-methyl butyl acrylate, and combinations thereof.

26. The method of claim 3, wherein component B is selected from the group consisting of methyl(meth)acrylate, ethyl(meth)acrylate, isobornyl(meth)acrylate, and combinations thereof.

27. The method of claim 3, wherein the hydroxy alkyl(meth)acrylate is selected from the group consisting of 2-hydroxyethyl(meth)acrylate, 3-hydroxypropyl(meth)acrylate, and combinations thereof.

28. The method of claim 3, wherein the N-alkyl substituted (meth)acrylamide is N-octyl acrylamide.

29. The method of claim 3, wherein the N,N-dialkyl substituted (meth)acrylamide is selected from the group consisting of N,N-dimethyl acrylamide, N-N diethylacrylamide, and a combination thereof.

30. The method of claim 3, wherein the tertiary amine, alicyclic amine, and aromatic amine is selected from the group consisting of vinyl pyridine, vinyl imidazole, and N,N-dialkyl amino alkyl(meth)acrylate, wherein the alkyl has 1 to 4 carbon atoms.

31. The method of claim 3, wherein the electro-conductive trace has an initial resistance value when the adhesive is attached to the first substrate and the trace shows an increase in resistance of less than 50% after the article has been conditioned for forty days at 60° C. and 90% relative humidity.

32. The method of claim 3, wherein the electro-conductive trace has an initial resistance value when the adhesive is attached to the first substrate and the trace shows an increase in resistance of less than 20% after the article has been conditioned for forty days at 60° C. and 90% relative humidity.

33. The method of claim 3, wherein the first and second substrates are selected from the group consisting of plastic and glass.

34. The method of claim 3, wherein the curing step uses an ultraviolet light source or an infrared light source.

35. The method of claim 3, wherein the adhesive composition further comprises a crosslinker.
